(19) United States
(12) Patent Application Publication
(10) Pub. No.: US 2018/0173308 A1
(43) Pub. Date: Jun. 21, 2018

(54) Systems and Methods for Breathing Sensory Experience Within a Virtual Reality Environment

(71) Applicant: Christopher Lee Smith, San Carlos, CA (US)

(72) Inventor: Christopher Lee Smith, San Carlos, CA (US)

(21) Appl. No.: 15/889,064

(22) Filed: Feb. 5, 2018

Related U.S. Application Data
(60) Provisional application No. 62/430,844, filed on Dec. 6, 2016.

(51) Int. Cl. G06F 3/01; G09G 5/373

(52) U.S. Cl. CPC G06F 3/015; G09G 5/373; G09G 2320/0666; G09G 2354/00; G09G 2340/045; G06F 3/014

(57) ABSTRACT

Provided herein are system, method and/or computer program product embodiments for providing a virtual reality breathing environment using a sensor in communication with a virtual reality system. Embodiments receive, from a breathing sensor, a signal indicative of an intensity of breathing of a user and displaying a visualization on a user display. Embodiments further compute a modification of a visual characteristic of the visualization based on the signal, the magnitude of the modification corresponding to the intensity of breathing of the user. The visualization is updated based on the modification.

### BACKGROUND

### Technical Field

Embodiments generally relate to virtual reality systems and environments.

### Background

Virtual reality systems provide a computer-generated simulation of an image or environment that can be interacted with in a seemingly real or physical way. Typically, the systems use special electronic equipment, such as a helmet or a headset with a screen inside that shows objects, still pictures or moving pictures for the purpose of creating a virtual world/environment for the user, typically in three dimensions.

A wide field-of-view display (e.g. on a projection screen) or a head mounted display is utilized to give the user an illusion of spatial immersion, or presence, within the virtual environment. Head-mounted displays offer an immersive virtual reality environment, with a head position sensor to control the displayed images so they appear to remain stable in space when turning the head or moving through the virtual environment.

### SUMMARY

Provided herein are system, method and/or computer program product embodiments for providing a virtual reality breathing environment using a sensor in communication with a virtual reality system. Embodiments receive, from a breathing sensor, a signal indicative of an intensity of breathing of a user and displaying a visualization on a user display. Embodiments further compute a modification of a visual characteristic of the visualization based on the signal, the magnitude of the modification corresponding to the intensity of breathing of the user. The visualization is updated based on the modification.

The embodiments disclosed above are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

The accompanying drawings are incorporated herein and form a part of the specification.

FIG. 1 illustrates a virtual reality system for providing a breathing interactive interface, according to an example embodiment.

FIG. 2 illustrates a virtual reality headset with an integrated breathing sensor, according to an example embodiment.

FIG. 3 illustrates a virtual reality breathing interaction interface, according to an example embodiment.

FIG. 4 shows an interactive virtual reality environment responsive to breathing intensity, according to an example embodiment.

FIG. 5 shows an interactive virtual reality environment responsive to breathing intensity and other user inputs, according to an example embodiment.

FIG. 6 shows another interactive virtual reality environment responsive to breathing intensity and other user inputs, according to an example embodiment.

FIG. 7 shows another interactive virtual reality environment responsive to breathing intensity and other user inputs, according to an example embodiment.

FIG. 8 shows another interactive virtual reality environment responsive to breathing intensity, according to an example embodiment.

FIG. 9 is an example computer system useful for implementing various embodiments.

### DETAILED DESCRIPTION

Provided herein are system, method and/or computer program product embodiments, and/or combinations and sub-combinations thereof, for providing a virtual reality breathing interface using a sensor integrated into a virtual reality headset.

While traditionally associated with video games, virtual reality (VR) systems are finding increasingly varied applications in multiple fields. VR systems have found healthcare, military, and educational applications, among others. Embodiments described herein provide a system and methods to enhance any VR application with a breathing interface that allows VR environments to respond to the user's breathing. For example, the breathing interface may be applied to a VR meditation guidance system to help people meditate. In another example, a breathing interface may be applied to a VR system used in a medical diagnostic environment where a user's breathing patterns are monitored. However, embodiments are not limited to the applications described herein, and may be applied to any VR system that may benefit from a breathing interface.

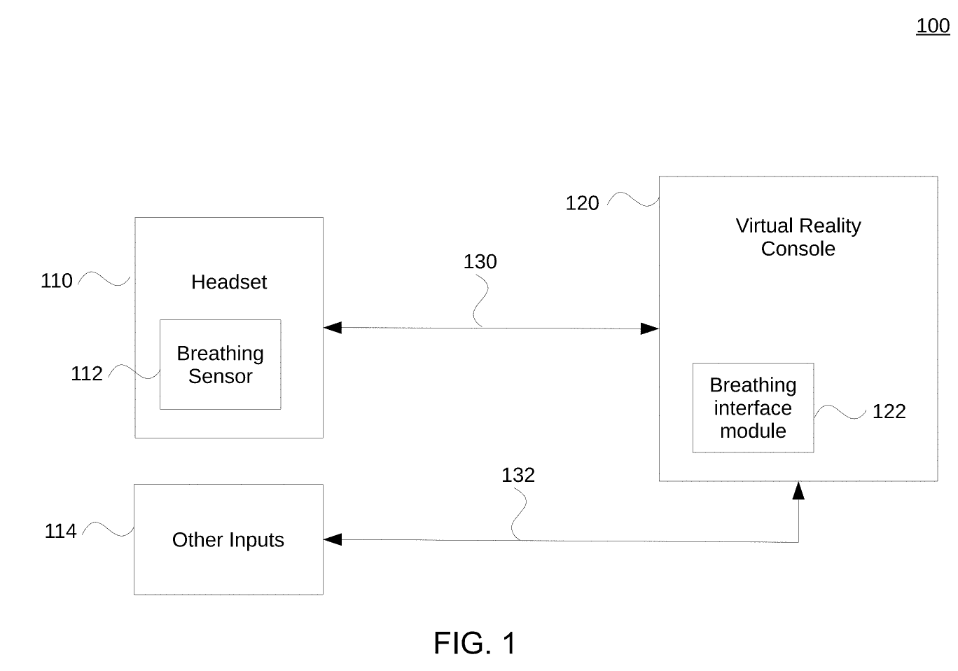

FIG. 1 shows a virtual reality system 100 for providing a breathing interactive interface, according to an example embodiment. System 100 includes a VR headset 110 connected to a virtual reality console 120 through a communications medium 130. Communications medium 130 may be any medium suitable to transmit information from a headset 110 to console 120, such as, by way of example, a wired connection (e.g., serial cable, a USB cable, circuitry, bus, etc.), a wireless connection (e.g., WiFi, Bluetooth, etc.), a network connection (LAN, WAN, Internet, etc.) or any combination thereof. Virtual reality console 120 may be any computing device configured with software to generate and render a VR environment in a headset, such as, by way of example, a personal computer, a gaming console, a special-purpose computer, a smartphone, etc. The virtual environment may include any sensory experience suitable for any particular application, for example, video rendering on the headset 110, audio, vibrations, etc.

VR headset 110 may include various sensors that generate input for VR console 120. For example, VR headset 110 may include one or more movement sensors, such as, for example, accelerometers, gyroscopes, infrared sensors, etc. VR console 120 receives input from headset 110 and renders the virtual reality environment accordingly. For example, movement sensors may allow the console 120 to know which direction the user is looking and render the appropriate images that show that direction in the virtual environment. VR system 100 may also include other inputs 114 communicating through a communications medium 132 with VR console 120. These inputs may be, as an example, a keyboard, a mouse, a gamepad controller, VR controller, VR glove, etc., and may also be used by VR console 120 to generate and render the virtual environment in real-time. It should be understood that mediums 130 and 132 may be the same or separate mediums.

In particular embodiments, VR headset 110, VR console 120, and communications medium 130 may be implemented in a single device, such as, by way of example, a smartphone. As an example, a smartphone may be inserted into a VR viewer and perform both the sensing and virtual reality environment display.

In an embodiment, VR headset 110 includes a breathing sensor 112. Breathing sensor 112 may be any type of sensor configured to measure breathing intensity through the nose or mouth. In an embodiment, breathing sensor 112 may be a temperature sensor configured to detect temperature differences caused by nasal or mouth breathing. As an example, the airflow through the sensor may cause the sensor to generate a signal that corresponds to the intensity of the breathing.

In an embodiment, VR headset 110 communicates the breathing sensor readings to VR console 120, which processes them through a breathing interface module 122. Breathing interface module 122 may include any processing logic that can comprise hardware (e.g., circuitry, dedicated logic, programmable logic, microcode, etc.), software (e.g., instructions run on a processing device), or any combination thereof. Module 122 may receive breathing signal information from VR headset 110 and generate a virtual environment response, such as, for example, a visual cue or visualization representing the breathing, a sound effect, etc.

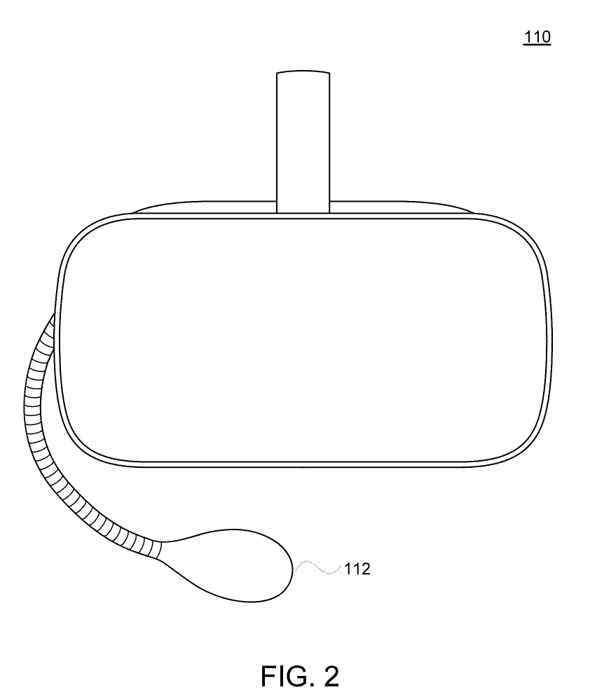

FIG. 2 shows a virtual reality headset 110 with an integrated breathing sensor 112, according to an example embodiment. In an embodiment, breathing sensor 112 may be a temperature sensor embedded on an electronic chip. Breathing sensor 112 may be fixed to the headset, or may be removably coupled to the headset. Breathing sensor 112 may be configured to detect temperature differences that airflow through the sensor may cause. In an embodiment, the sensor data is pre-processed by a processing unit in the headset before sending signals to the VR console 120. In an embodiment, VR console 120 sends raw sensor readings to the VR console 120 for processing.

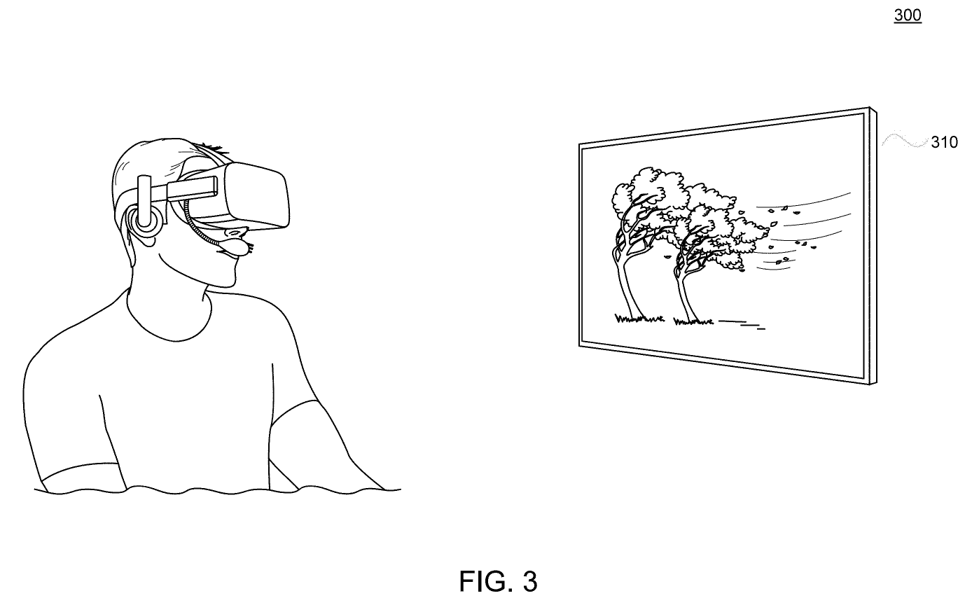

FIG. 3 illustrates a virtual reality breathing interaction interface, according to an example embodiment. Virtual reality console 120 may generate a virtual environment, such as the environment shown in display 310. In an embodiment, the VR console 120 displays the environment both on a headset and on a separate display 310. Other users that may want to see the environment without wearing the headset may view it through the separate display 310. It should be understood that displaying the environment on a display separate from the headset is optional. In an embodiment, the user is immersed in this environment through the use of the VR headset 110, and can interact with the environment through breathing. As an example, VR system 100 may generate a VR environment where the user is in a forest with trees and leaves rustling in the wind. When the user breathes out, the VR environment may show visible wind or generate sounds that match the intensity of the user's breathing. For example, the wind may be shown as dust, smoke, sparkles, or any suitable visual cue that illustrates the user's breathing. In an embodiment, the visual cues correspond to the breathing patterns and intensity of the user. For example, the harder the user breathes, the more intense the wind, smoke, lights, etc. may become. The breathing may also affect other elements in the environment. As an example, breathing may generate wind that moves leaves of a tree in a particular direction, or make the user move through the environment in a particular way. Furthermore, if the user breathes in a particular sequence or pattern, the VR console 120 may generate a particular reaction in the environment (e.g., a special effect). As an example, if the user breathes three times in a short interval at a particular frequency, the VR environment may generate a fire effect. Although this disclosure describes particular breathing patterns and VR outputs, this disclosure contemplates any suitable breathing patterns and VR outputs.

VR system 100 and the interactive environments described herein may be applied in any relevant field or manner, including by way of example, gaming, pain management therapy, post-traumatic stress disorder therapy, meditation guidance, etc. In an example, the VR console 120 may be configured to provide a meditation experience for the user. A meditation practitioner may find it beneficial to focus on his/her breathing throughout a meditation experience in order to relax and reduce stress. VR console 120 may be configured to generate a peaceful environment, such as an outdoor environment or a remote skyline. The user may then be guided through visual and/or audio cues to breathe and focus the mind in particular ways to promote relaxation. The VR system may provide feedback on the user's breathing, or guide the user to focus on the visual cues generated by the breathing. As an example, the breathing may generate a bright dust on the environment emanating from the user's point of view. The VR system may also guide the user to maintain or change their breathing behavior based on the received sensor inputs.

In another example, the VR console 120 may be configured to provide a therapeutic or biofeedback system. The VR console 120 may guide a user through a series of steps and breathing exercises to assess the user's health. The guidance may proceed forward based on the user's breathing (e.g., “Breathe deeply twice to continue”). Breathing data may be recorded and used for diagnostic purposes. Although breathing interface applications have been described in particular manner, this disclosure contemplates breathing interface applications in any suitable manner.

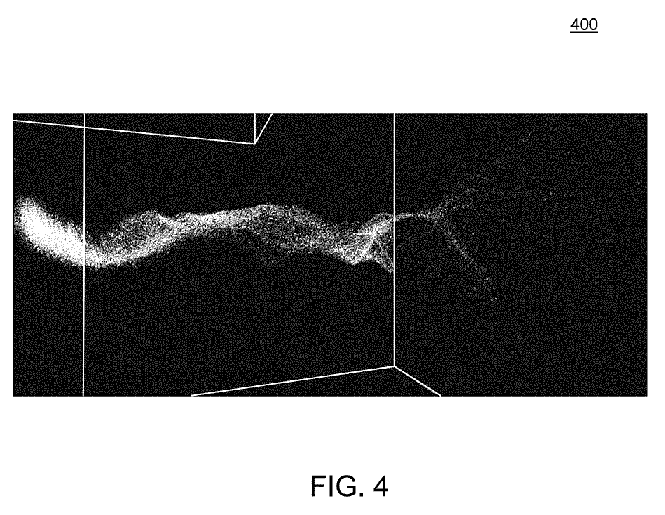

FIG. 4 shows an interactive virtual reality environment 400 responsive to breathing intensity, according to an example embodiment. The example of FIG. 4 shows air particles that represent the breathing of a user, and are generated and displayed based on the breathing intensity of the user along with the direction of the VR headset 110.

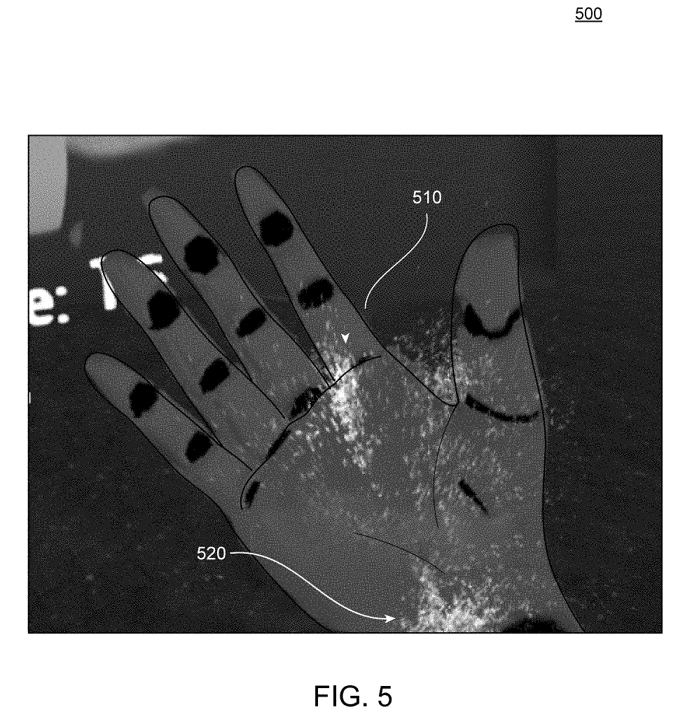

In particular embodiments, VR console 120 may be configured to generate an environment that enables using other inputs 114 to further interact with the breathing-generated virtual response. FIG. 5 shows an interactive virtual reality environment 500 responsive to breathing intensity and other user inputs, according to an example embodiment. As an example, environment 400 may show a virtual hand 510 positioned based on signals received from a handheld controller or glove in communication with VR console 120. The environment may allow the user to interact with air particles 520 generated by the user's breathing, such as by moving them, fanning them, touching them, holding them, etc. Environment 500 may simulate any physics rules for the particles, allowing for the illusion that the user is interacting with his/her breathing.

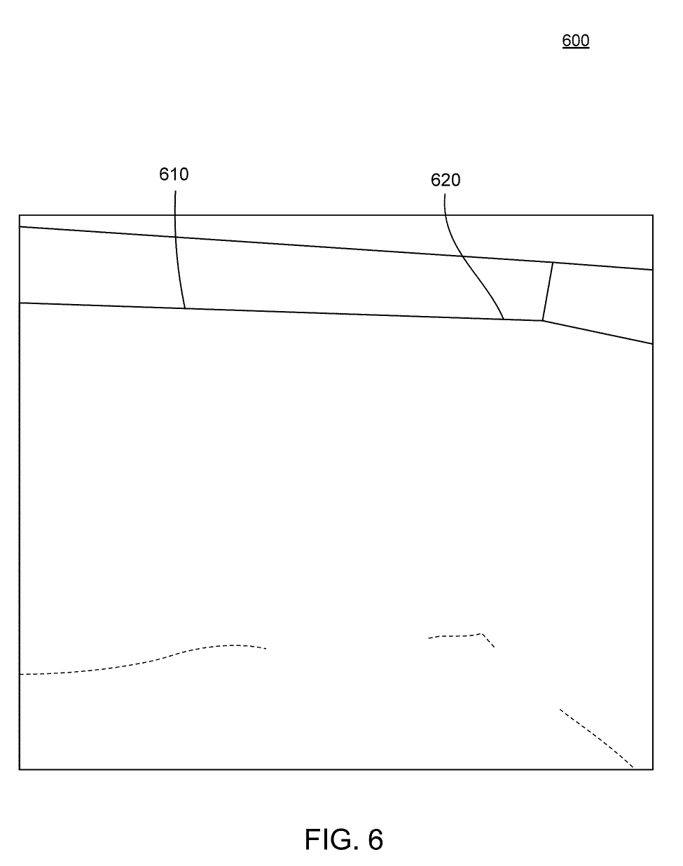

FIG. 6 shows another interactive virtual reality environment 600 responsive to breathing intensity and other user inputs, according to an example embodiment. In an example, VR console 120 may generate a virtual environment 600 showing the user inside a container filled with liquid 620 (e.g., water). As the user breathes, the water rises and fills the container with more liquid 620. The faster the user breathes, the faster the container fills with liquid. The user may further interact with the liquid 620 through other inputs. As an example, a virtual hand 610 may interact with the liquid through simulated physics in the virtual environment.

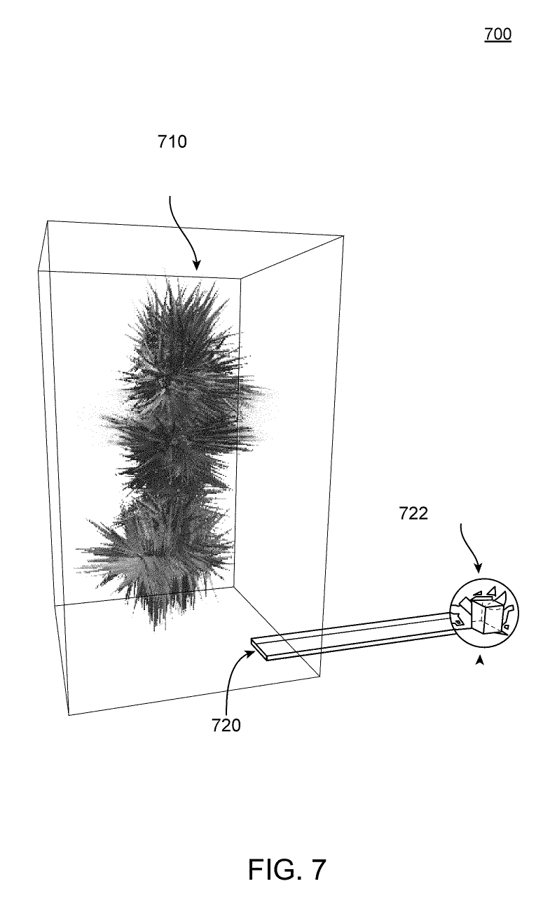

FIG. 7 shows another interactive virtual reality environment 700 responsive to breathing intensity and other user inputs, according to an example embodiment. The example discussed with reference to FIG. 7 may be used, for example, in therapeutic settings. Virtual environment 700 may show a visualization 710 representing a user's pain and a user interface element, such as slider elements 720 and 722, as shown in FIG. 7. The user may be prompted to rate the user's current pain level through the interface, e.g., by moving the slider using an input 114. Pain visualization 710 may then be adjusted based on the specified pain level, e.g., larger for higher pain, a different color, etc. The user may then be prompted to breathe in a particular manner. As an example, as the user breathes the pain visualization may shrink in proportion to the intensity, frequency or number of breathes the user performs.

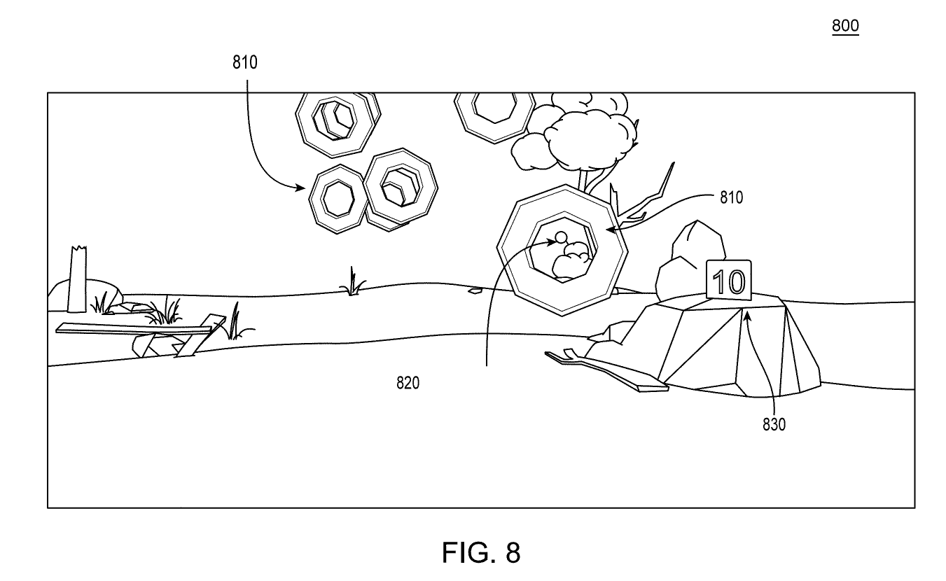

FIG. 8 shows another interactive virtual reality environment 800 responsive to breathing intensity, according to an example embodiment. Environment 800 may comprise a VR game showing hoops 810 and a ball 820. Ball 820 may move responsive to the user's breathing, and the object of the game may be for the user to move the ball through as many hoops as possible. A score 830 may be shown. In particular embodiments, the ball's may be moved in a direction based on the direction of VR headset 110, and at a velocity or acceleration corresponding to a breathing intensity.

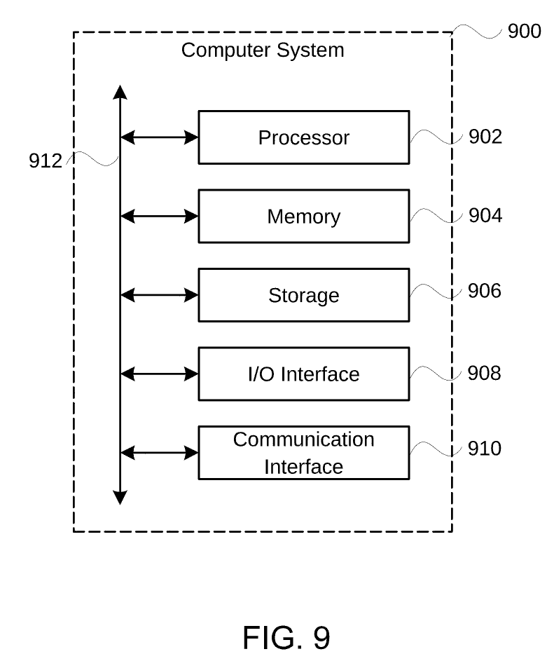

FIG. 9 illustrates an example computer system 900. In particular embodiments, one or more computer systems 900 perform one or more steps of one or more methods described or illustrated herein. In particular embodiments, one or more computer systems 900 provide functionality described or illustrated herein. In particular embodiments, software running on one or more computer systems 900 performs one or more steps of one or more methods described or illustrated herein or provides functionality described or illustrated herein. Particular embodiments include one or more portions of one or more computer systems 900. Herein, reference to a computer system may encompass a computing device, and vice versa, where appropriate. Moreover, reference to a computer system may encompass one or more computer systems, where appropriate.

This disclosure contemplates any suitable number of computer systems 900. This disclosure contemplates computer system 900 taking any suitable physical form. As example, computer system 900 may be an embedded computer system, a desktop computer system, a laptop or notebook computer system, a mainframe, a mobile telephone, a personal digital assistant (PDA), a server, a tablet computer system, or a combination of two or more of these. Where appropriate, computer system 900 may include one or more computer systems 900; be unitary or distributed; span multiple locations; span multiple machines; span multiple data centers; or reside in a cloud, which may include one or more cloud components in one or more networks. Where appropriate, one or more computer systems 900 may perform without substantial spatial or temporal limitation one or more steps of one or more methods described or illustrated herein. As an example, one or more computer systems 900 may perform in real time or in batch mode one or more steps of one or more methods described or illustrated herein. One or more computer systems 900 may perform at different times or at different locations one or more steps of one or more methods described or illustrated herein, where appropriate.

In particular embodiments, computer system 900 includes a processor 902, memory 904, storage 906, an input/output (I/O) interface 908, a communication interface 910, and a bus 912. Although this disclosure describes and illustrates a particular computer system having a particular number of particular components in a particular arrangement, this disclosure contemplates any suitable computer system having any suitable number of any suitable components in any suitable arrangement.

In particular embodiments, processor 902 includes hardware for executing instructions, such as those making up a computer program. As an example, to execute instructions, processor 902 may retrieve (or fetch) the instructions from an internal register, an internal cache, memory 904, or storage 906; decode and execute them; and then write one or more results to an internal register, an internal cache, memory 904, or storage 906. In particular embodiments, processor 902 may include one or more internal caches for data, instructions, or addresses. This disclosure contemplates processor 902 including any suitable number of any suitable internal caches, where appropriate. In particular embodiments, processor 902 may include one or more internal registers for data, instructions, or addresses. This disclosure contemplates processor 902 including any suitable number of any suitable internal registers, where appropriate. Where appropriate, processor 902 may include one or more arithmetic logic units (ALUs); be a multi-core processor; or include one or more processors 902. Although this disclosure describes and illustrates a particular processor, this disclosure contemplates any suitable processor.

In particular embodiments, memory 904 includes main memory for storing instructions for processor 902 to execute or data for processor 902 to operate on. As an example, computer system 900 may load instructions from storage 906 or another source (such as, for example, another computer system 900) to memory 904. Processor 902 may then load the instructions from memory 904 to an internal register or internal cache. To execute the instructions, processor 902 may retrieve the instructions from the internal register or internal cache and decode them. During or after execution of the instructions, processor 902 may write one or more results (which may be intermediate or final results) to the internal register or internal cache. Processor 902 may then write one or more of those results to memory 904. In particular embodiments, processor 902 executes only instructions in one or more internal registers or internal caches or in memory 904 (as opposed to storage 906 or elsewhere) and operates only on data in one or more internal registers or internal caches or in memory 904 (as opposed to storage 906 or elsewhere). One or more memory buses (which may each include an address bus and a data bus) may couple processor 902 to memory 904. Bus 912 may include one or more memory buses, as described below. In particular embodiments, memory 904 includes random access memory (RAM). This RAM may be volatile memory, where appropriate Memory 904 may include one or more memories 904, where appropriate. Although this disclosure describes and illustrates particular memory, this disclosure contemplates any suitable memory.

In particular embodiments, storage 906 includes mass storage for data or instructions. As an example, storage 906 may include a hard disk drive (HDD), a floppy disk drive, flash memory, an optical disc, a magneto-optical disc, magnetic tape, or a Universal Serial Bus (USB) drive or a combination of two or more of these. Storage 906 may include removable or non-removable (or fixed) media, where appropriate. Storage 906 may be internal or external to computer system 900, where appropriate. In particular embodiments, storage 906 is non-volatile, solid-state memory. In particular embodiments, storage 906 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 906 taking any suitable physical form. Storage 906 may include one or more storage control units facilitating communication between processor 902 and storage 906, where appropriate. Where appropriate, storage 906 may include one or more storages 906. Although this disclosure describes and illustrates particular storage, this disclosure contemplates any suitable storage.

In particular embodiments, I/O interface 908 includes hardware, software, or both, providing one or more interfaces for communication between computer system 900 and one or more I/O devices. Computer system 900 may include one or more of these I/O devices, where appropriate. One or more of these I/O devices may enable communication between a person and computer system 900. As an example, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 908 for them. Where appropriate, I/O interface 908 may include one or more device or software drivers enabling processor 902 to drive one or more of these I/O devices. I/O interface 908 may include one or more I/O interfaces 908, where appropriate. Although this disclosure describes and illustrates a particular I/O interface, this disclosure contemplates any suitable I/O interface.

In particular embodiments, communication interface 910 includes hardware, software, or both providing one or more interfaces for communication (such as, for example, packet-based communication) between computer system 900 and one or more other computer systems 900 or one or more networks. As an example, communication interface 910 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 910 for it. As an example, computer system 900 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 900 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 900 may include any suitable communication interface 910 for any of these networks, where appropriate. Communication interface 910 may include one or more communication interfaces 910, where appropriate. Although this disclosure describes and illustrates a particular communication interface, this disclosure contemplates any suitable communication interface.

In particular embodiments, bus 912 includes hardware, software, or both coupling components of computer system 900 to each other. As an example, bus 912 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 912 may include one or more buses 912, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

It is to be appreciated that the Detailed Description section, and not the Summary and Abstract sections (if any), is intended to be used to interpret the claims. The Summary and Abstract sections (if any) may set forth one or more but not all exemplary embodiments of the invention as contemplated by the inventor(s), and thus, are not intended to limit the invention or the appended claims in any way.

While the invention has been described herein with reference to exemplary embodiments for exemplary fields and applications, it should be understood that the invention is not limited thereto. Other embodiments and modifications thereto are possible, and are within the scope and spirit of the invention. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments may perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

The breadth and scope of the invention should not be limited by any of the above-described exemplary embodiments, but should be defined only in accordance with the following claims and their equivalents.

What is claimed is:

1. A computer-implemented method comprising, by at least one processor:
receiving, from a breathing sensor, a signal indicative of an intensity of breathing of a user;
displaying a visualization on a user display;
computing a modification of a visual characteristic of the visualization based on the signal, wherein a magnitude of the modification corresponds to the intensity of breathing of the user; and
updating the displaying of the visualization based on the modification.

2. The method of claim 1, further comprising:
receiving a user input from an input device;
computing another modification of the visual characteristic of the visualization based on the user input; and
updating the display of the visualization based on the other modification.

3. The method of claim 1, wherein the user display comprises a virtual reality headset.

4. The method of claim 2, wherein the input device comprises a handheld controller in communication with the user display.

5. The method of claim 1, wherein the visualization is dynamic.

6. The method of claim 3, wherein the visual characteristic comprises a velocity or acceleration of the visualization.

7. The method of claim 1, wherein the visual characteristic comprises a size of the visualization.

8. The method of claim 1, wherein the visual characteristic comprises a color of the visualization.

9. A system, comprising:
a virtual reality headset;
a breathing sensor in communication with the virtual reality headset;
a memory; and
at least one processor coupled to the memory and configured to:
receive, from a breathing sensor, a signal indicative of an intensity of breathing of a user;
display a visualization on a user display;
compute a modification of a visual characteristic of the visualization based on the signal, wherein a magnitude of the modification corresponds to the intensity of breathing of the user; and
update the display of the visualization based on the modification.

10. The system of claim 9, further comprising:
an input device; and
wherein the at least one processor further configured to:
receive a user input from an input device;
compute another modification of the visual characteristic of the visualization based on the user input; and
update the display of the visualization based on the other modification.

11. The system of claim 9, wherein the user display comprises a virtual reality headset.

12. The system of claim 11, wherein the input device comprises a handheld controller in communication with the user display.

13. The system of claim 9, wherein the visualization is dynamic.

14. The system of claim 13, wherein the visual characteristic comprises a velocity or acceleration of the visualization.

15. A tangible computer-readable device having instructions stored thereon that, when executed by at least one computing device, causes the at least one computing device to perform operations comprising:
receiving, from a breathing sensor, a signal indicative of an intensity of breathing of a user;
displaying a visualization on a user display;
computing a modification of a visual characteristic of the visualization based on the signal, wherein a magnitude of the modification corresponds to the intensity of breathing of the user; and
updating the displaying of the visualization based on the modification.

16. The method of claim 1, further comprising:
receiving a user input from an input device;
computing another modification of the visual characteristic of the visualization based on the user input; and
updating the display of the visualization based on the other modification.

17. The method of claim 1, wherein the user display comprises a virtual reality headset.

18. The method of claim 2, wherein the input device comprises a handheld controller in communication with the user display.

19. The method of claim 1, wherein the visualization is dynamic.

20. The method of claim 3, wherein the visual characteristic comprises a velocity or acceleration of the visualization.
